(19) United States
(12) Patent Application Publication
(10) Pub. No.: US 2015/0153489 A1
(43) Pub. Date: Jun. 4, 2015

(54) Light filters that minimize suppression of melatonin and loss of color perception

(71) Applicant: Photoprotective Technologies Inc., San Antonio, TX (US)

(72) Inventors: James M. Gallas, San Antonio, TX (US); John-Paul Lozano, San Antonio, TX (US)

(73) Assignee: Photoprotective Technologies Inc., San Antonio, TX (US)

(21) Appl. No.: 13/999,867

(22) Filed: Mar. 28, 2014

Related U.S. Application Data
(60) Provisional application No. 61/960,147, filed on Sep. 11, 2013.

(51) Int. Cl. G02B 5/20

(52) U.S. Cl. CPC G02B 5/208

(57) ABSTRACT

A light filter that utilizes UV and visible light-absorbing dyes with transmission spectra in accord with the action spectra for suppression of melatonin so as to permit a maximum production of melatonin in humans during night time exposure to high energy visible light.

### CROSS-REFERENCE TO RELATED APPLICATIONS

This Application references two earlier Provisional Applications: 61/960,147 filed on Sep. 11, 2013 (Gallas and Lozano) relating to the Melatonin Production Factor; and 61/964,773 filed on Jan. 14, 2014 relating to a Light Filter that maximizes: Melatonin Production Factor, Eye protection factor; Scotopic Luminous transmission and Minimize Errors on the Fm100 color tests.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of light filters and more specifically it is in the technical field of light filters that allow maximum the production of melatonin in humans during night time exposure to high energy visible light.

Sleep disorders have long-plagued humans and many causes have been identified including diet-related factors such as caffeine and alcohol; and non-diet factors have included stress and anxiety.

One factor is the increased use of self-luminous and handheld electronic devices such as televisions, tablet pc's, Ipads, and cell phones. Such devices could promote sleep loss in two ways. The preponderance of these devices could be a source of excess mental stimulation—especially when used at night time; the second way, and the one addressed in this invention, is that electronic devices can disrupt sleep because of the excess emissions of higher energy visible light. Recent research indicates that the higher energy light from blue-light-rich LED displays—when used at nighttime—can suppress the production of melatonin.

At the same time, medical science has associated chronic sleep loss with many of the major diseases of the contemporary world—including cancer, Alzheimers and diseases of the immune system.

Thus, many scientists believe blue light should be avoided or reduced at night time—either by software to control the lighting spectrum, or by using appropriate eyewear with filters that reduce blue light.

Choosing a filter to reduce the intensity of light coming from an electronic display at nighttime presents several challenges. If one color is predominantly decreased, it is likely that the perception of color will be compromised. A filter that eliminates all of the blue light will prevent any light-induced suppression of melatonin; but the perception of color will be greatly compromised. Even a relatively low transmission of blue light will, in general, cause a loss in the perception of color for someone viewing colors through such a filter. Currently, a variety of light filters—generally tinted yellow and in the form of eyewear or in the form of thin films to cover electronic displays—exist on the market; but generally, yellow-tinted light filters disrupt the perception of color as is generally demonstrated by the Farnsworth-Munsell 100 Hue test. This is an important technical issue because millions of different colors may be displayed over the course of viewing time by one or more people; and chromaticity shifts will occur because of the wavelength-selective light filtration by many light filters.

The applicant has found that subjects wearing eye glasses with lenses that contain melanin and materials made from the oligomerization of 3 hydroxy-kynurenine while taking the Farnsworth-Munsell 100 color test will consistently score with very low errors. Low scores occur even when the melanin materials are used over a wide range of concentrations of the melanin and even when melanins from a wide range of preparations were used to make the light filters, or when various molecular weight fractions of melanin have been used as described in U.S. Pat. No. 8,133,414 and U.S. Pat. No. 8,048,343. Applicants have further found that although the colors of these different molecular weight fractions are different (ranging from brown to red to yellow), lenses made with these materials provide good color perception.

Whatever light filter is ultimately proposed to reduce blue light, it will be characterized by its transmission spectrum. It is an essential feature of this invention that there are currently no guidelines for characterizing transmission spectra (for example the shape of the spectra or its specific functional dependence on the wavelength of light) for selecting light filters that will reduce blue light and still preserve the perception of color. Nor has there been any guideline for how much blue light should be reduced in order to preserve the production of night time levels of melatonin.

### BRIEF SUMMARY OF THE INVENTION

Applicants have found a way to quantify the ability of a given light filter to preserve the production of melatonin and a way to predict the ability of a light filter to preserve the perception of color—both through the specific transmission spectrum of the light filter. It therefore offers guidelines to the consumer and to the manufacturer, for the first time, to select and make light filters with predictable and quantifiable ability to reduce the part of the HEV light spectrum responsible for disrupting the production of melatonin and the perception of color.

### Brief Description of the Several Views of the Drawing

FIG. 1 shows the action spectrum S_{λ} for the suppression of melatonin

FIG. 2 shows the emission spectrum for the iPad

FIG. 3 shows the transmission spectrum for a yellow melanin computer lens.

FIG. 4 shows the optical densities of several types of melanin and also the oligomerization products of 3 hyroxy-kynurenine plotted vs wavelength—in nanometers.

FIG. 5 shows the spectra of the materials of FIG. 4 wherein the logarithm of the optical densities of FIG. 1b are plotted vs wavelength—in nanometers. The different data sets form straight lines.

FIG. 6 shows the transmission spectrum of a film cast from a solution of a product of the oligomerization of 3 hydroxy-kynurenine (3-OHK) modified by bleaching and fractionation and combined with Polyester in a cast thin film .

FIG. 7 shows spectra of the film of FIG. 6 wherein the logarithm of the optical density is plotted vs wavelength—in nanometers and forms a straight line.

Table 1 shows a portion of an Excel file that outlines the calculation of the MPF described in Example 1.

Table 2 shows an Excel regression data analysis for the spectra in FIG. 5

### DETAILED DESCRIPTION OF THE INVENTION

The present invention defines the physical characteristics of optical light filters that quantify their ability to preserve the production of melatonin and the perception of color when used during nighttime exposure to high energy visible light.

The Melatonin Production Factor (MPF), introduced here for the first time, factors in the spectrum of the light source, the action spectrum for the suppression of melatonin and the specific transmission spectrum of the light filter. Its value informs the consumer how much longer he or she can view a self-luminous electronic display with the specific light filter—than without any light filter—to get the same dose of melatonin-suppressing light. Because of the wavelength-selective character of the melatonin action spectrum, a desirable high value for the MPF calls for a selective reduction blue light which is in conflict with the perception of color. This is especially true for self-luminous electronic displays because of the very large number of possible color hues. A new criteria for the preservation of the perception of color is therefore also introduced here for the first time—that the logarithm of the optical absorption of these light filters are linear functions of the wavelength. The invention therefore introduces guidelines for selecting light filters based upon their optical transmission spectrum. These guidelines can provide a way for manufacturers and consumers to select light filters that assure the highest production of melatonin while still preserving the perception of color.

The objects of this invention are:
1) quantify the ability of a light filter to preserve the production of melatonin during nighttime use of self-luminous electronic displays—to be called the melatonin production factor, or MPF;
2) select light filters that limit the average transmission of the light between 520nm and 525 nm to a range of 50% to 90%; preferably 60%
3) present a guideline for selecting light filters—characterized by their transmission spectra—that preserve the perception of color;
4) Use 1), 2) and 3) in order to select light filters that provide the highest values of MPF while still preserving the perception of color.

Melatonin Production Factor.

In order to quantify the ability of a light filter to preserve the production of melatonin, a Melatonin Production Factor (MPF) is defined. This MPF is introduced as the reciprocal 1/Tₛₘ of the transmission Tₛₘ of melatonin-suppressing high energy visible light according to:

Tₛₘ=Σ_{λ}S_{λ}A_{λ}τ_{λ}/Σ_{λ}SₓA_{λ}. (Equation 1)

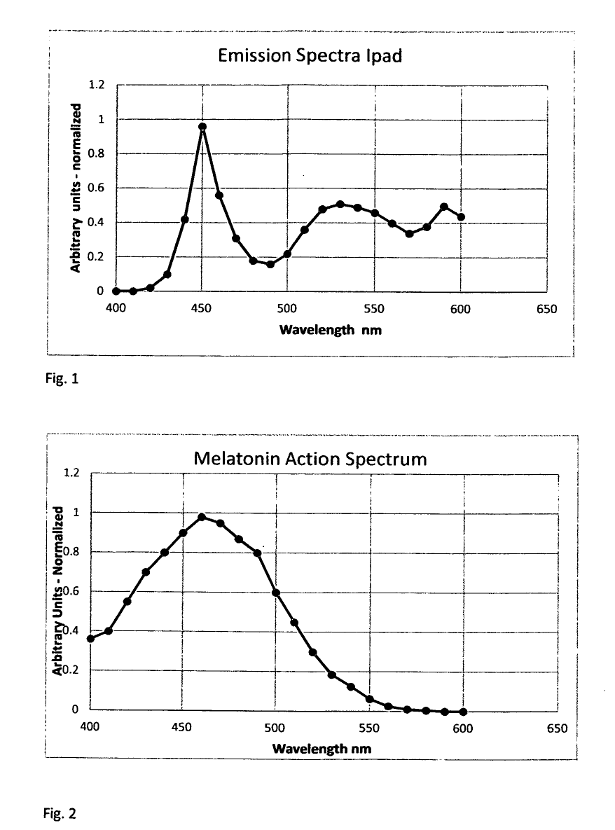

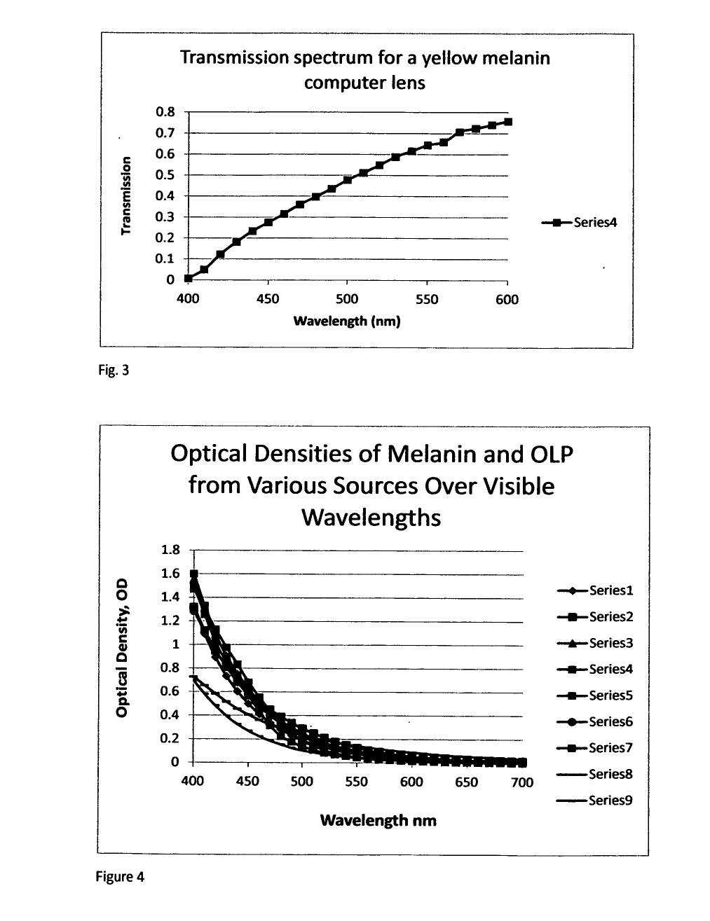

In the above equation, Tₛₘ is the average transmission of melatonin-suppressing light; S_{λ} is the emission at wavelength λ for a specific light source (for example, a cool white fluorescent light bulb or a self-luminous electronic display as in FIG. 1); A_{λ} is the action for the suppression of melatonin at wavelength λ (FIG. 2); t_{λ} is the transmission of the specific light filter (FIG. 3); and Σ_{λ} represents the sum of these products over the wavelength range of 400 nm to about 600 nm where the action S_{λ} is defined and where the wavelength 400 nm represents the limit of the shorter-wavelength transmission of the human lens. The source spectrum S_{λ} is shown in FIG. 1.

A low value of Tₛₘ by a specific light filter will correspond to a small dose of the light that causes a suppression of the production of melatonin. Therefore its reciprocal, 1/Tₛₘ, will correspond to a high value of filtration of this light and the applicants propose that the factor for the production of melatonin should be defined as:

MPF=1/Tₛₘ. (Equation 2)

Equations 1) and 2) therefore define and describe a system for rating a light filter for its ability to preserve the production of melatonin

Another object of this invention is to devise the rating system above in terms of a software program that uses the transmission spectrum of the light filter t_{λ}, as an input and the rating, MP, as an output of the software.

### EXAMPLE 1

### An Excel Spreadsheet Showing a Calculation of the MPF

In this example, Applicants created an Excel spreadsheet that uses equations 1 and 2 and the data of FIGS. 1, 2, and 3 to determine the rating, MPF. Column A of the spreadsheet has the wavelength running from 400 nm in cell A4 to 600 nm in cell A24. In column B, the action spectrum is digitized from the curve of the Action Spectrum, A_{□} of FIG. 2, It runs from cell B4 to cell B24. In column C, the light source emission spectrum, S_{λ} is digitized from the curve of the Spectrum of FIG. 1 for the Ipad; it runs from cell C4 to cell C24.

Column D shows the product S_{λ}A_{λ} of S_{λ} and A_{λ}. and Cell D25 show the sum of these products. Column E contains the transmission data for the specific light filter (a yellow melanin computer lens) for which the MP value is to be determined. These data are taken directly from the transmission spectrum (FIG. 3) recorded for the light filter by the spectrophotometer.

Column G shows the product S_{λ} A_{λ} t_{λ} obtained by multiplying the elements of columns D and E and cell G25 shows the sum of these products. Finally, Cell I10 shows the Average Transmission of light,

Tₛₘ=Σ_{λ} S_{λ} A_{λ} t_{λ}/Σ_{λ} S_{λ}A_{λ}. and cell I12 shows the protection factor for the production of melatonin,

MP=1/Tₛₘ. In the current example, the transmission data for the computer lens containing a yellow melanin was inserted into column E and the values for Tₛₘ and MP are displayed respectively in Cells I10 and I12.

Applicants note that the source can be a superposition of light intensities and spectral distributions from multiple sources. One example, is the light emitted directly from an LCD display combined with room light, from a compact fluorescent bulb that is reflected off the surface of the same LCD display.

Applicants also note that improvements or refinements on the measurements of the action spectrum for melatonin suppression may occur from future research, however the general concepts presented here would still apply.

In addition, the light source itself could be modified for various reasons. For example, equation 1 for the value of Tₛₘ could be modified to factor in the average transmission spectrum of the human lens—for different age groups—could be entered into the another column of the spread sheet. In this case the MPF value would vary with age even for the same light filter. This spreadsheet will be useful to optometrists, opticians, ophthalmologists and other eyecare professionals who dispenses ophthalmic lenses and eyewear for indoors, for example computer glasses. Once a tint is selected for any lens, its transmission spectrum can be recorded with a spectrophotometer or it can be read from another source and inputted into the spreadsheet for an immediate determination of the MPF value. A higher MPF value means that the specific lens will cause correspondingly less suppression of melatonin. The rating would also underscore the importance of protection by yellow light filters for young people—in particular who have less ocular lens pigment.

While it is true that a yellow lens will general contribute to higher MPF values, it is also true that yellow lenses have a variety of transmission spectra and generally disrupt the perception of color. Such a loss in the perception of color is particularly undesirable for people working at a computer given the very large number of possible colors associated with the LCD display. A convenient way to measure a person's perception of color—while wearing a computer lens with a specific yellow tint—is the Farnsworth Munsell 100 online color test. The rating system described in this invention would allow the eyecare professional as well as the consumer to weigh the MPF value against the value obtained by the FM100 color test for the same ophthalmic lens.

Preservation of the Perception of Color.

A unique feature of lenses made with melanin is the persistent behavior that these lenses preserve the perception of color when used by people while taking the Famsworth-Munsell 100 color test. A variety of tests—involving different colors of melanin, prepared in a variety of ways—display this character of passing the FM 100 test. For this reason, the Applicant proposes that the perception of color will be preserved for any light filter that has a melanin optical spectrum—including melanins that have not yet been made.

The applicant has found that subjects wearing eye glasses with lenses that contain melanin and materials made from the oligomerization of 3 hydroxy-kynurenine while taking the Farnsworth-Munsell 100 color test will consistently score with very low errors. Low scores occur even when the melanin materials are used over a wide range of concentrations and even when melanins from a wide range of preparations were used to make the light filters or when various molecular weight fractions of melanin have been used as described in U.S. Pat. No. 8,133,414 and U.S. Pat. No. 8,048,343. Applicant has further found that although the colors of these different molecular weight fractions are different (ranging from brown to red to yellow) and although the shapes of the corresponding absorption spectra of these melanin fractions are different, the color preserving features of light filters made with any of these melanins still remain intact. Optical density spectra for various such melanins is shown in FIG. 4. These data suggest to the Applicants that there must be some common feature among the various absorption spectrum not obvious from the absorption spectra. It is an essential feature of this invention that Applicants have found that when these spectra are displayed with the logarithm of the optical density (ordinate) plotted as a function of wavelength (abscissa)—instead of the traditional optical density vs wavelength—the spectra all have a straight line. This feature is shown in FIG. 5. The only difference among these straight line spectra are the slopes of the straight lines. Furthermore, as the slope of the spectrum lines increase, this means that the color of the melanin shifts continuously from brown to yellow. Furthermore, this shift is an indicator that more blue light will be filtered and therefore a higher MPF will likely occur for a light filter made with such melanin. It is also an essential feature of this invention that melanin can serve as a paradigm for defining the shape and character of transmission spectra for dyes or tints wherein the perception of color is assured. Furthermore, Applicants show later in this Specification that the Farnsworth-Munsell 100 Hue test can be used to confirm the ability of a light filter with a specific transmission spectrum to preserve the perception of color. The value of this unexpected result is that, in the process of creating new melanins or in selecting dyes for light filters that yield higher MPF values, it is now possible to confirm that such new filters will preserve color—by inspection of the logarithm of their optical density spectra for linearity.

Criteria for linearity.

Regression analysis of the curves of FIG. 5 were made for a straight line passing through the spectrophotometric data using the data analysis option provided by Excel. R² values and the equation for a straight line for each of the ‘Series’ curves of FIG. 5 and are summarized in Table 2. The consistently high values of R² shown in Table 2 offers striking evidence of the linearity in the logarithm of the optical density of the melanin spectra for a variety of melanin representations.

Criteria for brightness.

Any filtration of visible light will diminish the perception of brightness in the room; that is, any filtration of room light will tend to make the room darker than what might be desired. In this invention, it will be assumed that mesoscopic conditions apply during night time viewing of the self-luminous electronic display and the Applicants assume here that the wavelength of maximum sensitivity will occur approximately at 520 nm to 525 nm and that the average transmission of the light between 520 nm and 525 nm should be in the range of 50% to 90%; preferably 60%.

### EXAMPLE 2

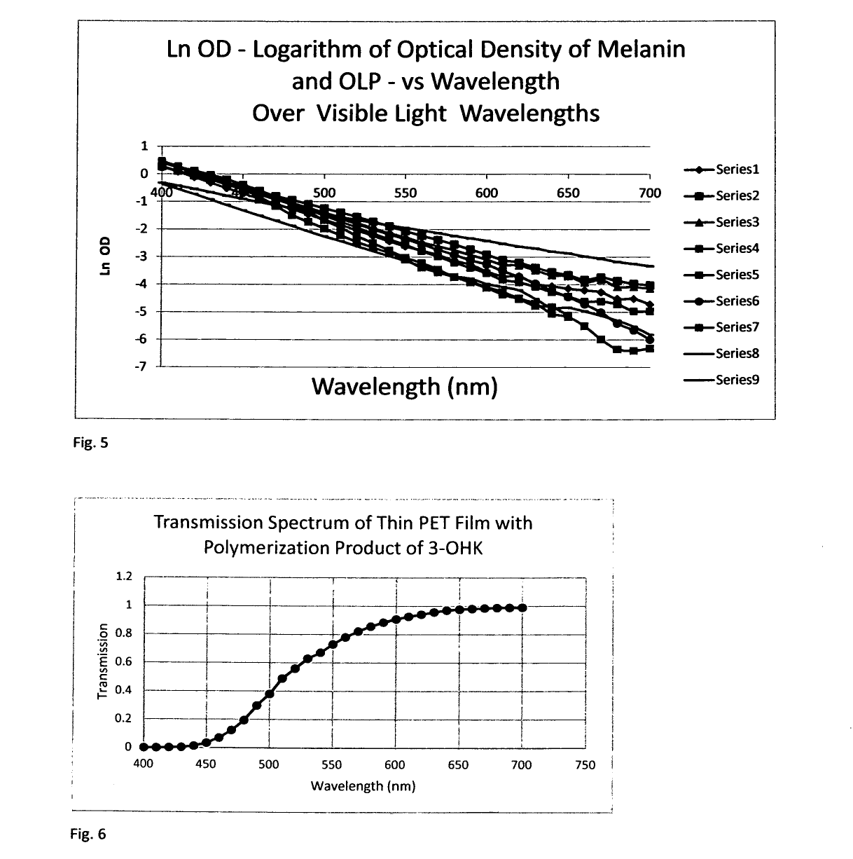

Using the methods of bleaching in combination with fractionation applied to a melanin or to an oligomerization product of 3 hydroxy-kynurenine—as described in U.S. Pat. No. 8,133,414 and U.S. Pat. No. 8,048,343—a light yellow brown powder was produced and supplied by Photoprotective Technologies. This powder was used to cast a thin film as follows: 1.33 grams and 10 grams of PET (Polyethylene terephthalate) plastic pellets were added to 100 grams of tetrahydrofuran and stirred for 24 hours. The solution was deposited onto a small glass slip and the solvent was allowed to evaporate under ambient conditions. A thin film was formed with a yellow brown tint. The transmission spectrum of the film was recorded in a spectrophotometer and is displayed in FIG. 6.

### EXAMPLE 3

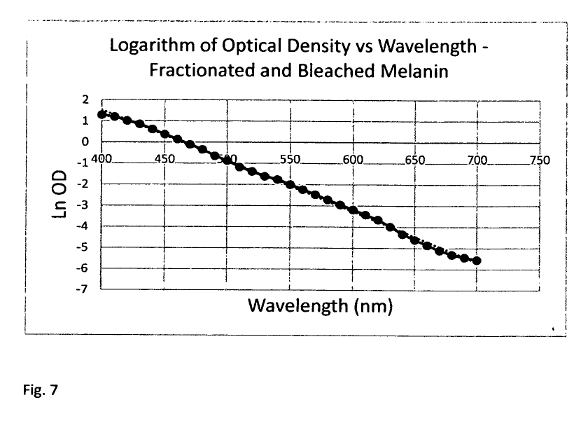

The transmission data of Example 2 was entered into the Excel spreadsheet for the calculation of the MPF as in Table 2. The MPF value is 6.05—close to the value of 6 preferred in this invention. The logarithm of its optical density is shown in FIG. 7 and the R² value for the straight line fitted to its data in an Excel routine is 0.997 which is a high value and in accord with the preferred values for R² of this invention.

### EXAMPLE 4

(This is a theoretical example). Multiple dyes (two or more) whose absorption spectra span the visible range of wavelengths are mixed. Distributions of concentrations are chosen so that: a) the logarithm of the optical density of the final product is linear as a function of wavelength between 400 nm and 700 nm; and b) that the slope of the line of the spectrum of a) is such that the MPF value is 6.0.

Criteria for identifying and selecting light filters for preserving the production of melatonin and color.

1. An absorption spectrum wherein the logarithm of the optical absorption for the light filter should form straight lines when plotted against the wavelengths over the region of visible light from 400 nm to 700 nm and with an R² value of 0.95 or greater and a preferred value for R² of 0.98 or greater;

2. The spectra of 1, wherein the slopes of the lines are sufficiently high to yield reasonably high values of the MPF—nominally this should be 2 or greater.

3. A minimum fractional increase in errors on the online FM100 color test taken by a person while wearing the light filters over the number of errors taken by the same person while not wearing the light filter to take the test—preferably not more than 20%.

Applicants underscore that the articles proposed in the current invention prioritize color perception over MPF values; that is, among the various light filters with high MPF values, only those light filters whose InOD values plotted against the visible light spectrum which are linear are to be accepted. Applicants point out that an alternative approach can involve the following process: a) write the equation (1) as a definite integral, Tₛₘ=∫S_{λ}A_{λ}τ_{λ}dλ/∫S_{λ}A_{λ}dλ; b) assume a functional form for the term A(λ)—for example a sum of two or more Gaussian curves that fit the shape of the action spectrum over the wavelength region from 400 nm to 600 nm. Likewise, assume a combination or sum of Gaussian or Lorentzian curves that fit the emission spectra reasonably well; then c) use the calculus of variations to determine the functional form of τ_{λ} that minimizes the value of Tₛₘ over the wavelength range between 400 n nm and 600 nm.

TABLE 1

| [symbol] | A | B | C | D | E | F | G | H | I |
|---|---|---|---|---|---|---|---|---|---|
| 2 | | A_{λ} | S_{λ} | S_{λ}A_{λ} | t_{λ} | | S_{λ}A_{λ}t_{λ} | | |
| 3 | nm | Melatonin Action Spectrum | Ipad emmision spectrum | | Lens/Filter | | | | |
| 4 | 400 | 0.36 | 0 | 0 | 0.007762471 | | 0 | | |
| 5 | 410 | 0.4 | 0 | 0 | 0.050234259 | | 0.001353 | | |
| 6 | 420 | 0.55 | 0.02 | 0.011 | 0.123026877 | | 0.012738 | | |
| 7 | 430 | 0.7 | 0.1 | 0.07 | 0.181970086 | | 0.078766 | | |
| 8 | 440 | 0.8 | 0.42 | 0.336 | 0.234422882 | | 0.237965 | | |
| 9 | 450 | 0.9 | 0.96 | 0.864 | 0.27542287 | | 0.173546 | | |
| 10 | 460 | 0.98 | 0.56 | 0.5488 | 0.316227766 | | 0.106435 | Tsm = | 0.35 |
| 11 | 470 | 0.95 | 0.31 | 0.2945 | 0.361409863 | | 0.062344 | | |
| 12 | 480 | 0.87 | 0.18 | 0.1566 | 0.398107171 | | 0.055874 | MP = | 2.83 |
| 13 | 490 | 0.8 | 0.16 | 0.128 | 0.436515832 | | 0.063179 | | |
| 14 | 500 | 0.6 | 0.22 | 0.132 | 0.478630092 | | 0.083084 | | |
| 15 | 510 | 0.45 | 0.36 | 0.162 | 0.512861384 | | 0.079134 | | |
| 16 | 520 | 0.3 | 0.48 | 0.144 | 0.549540874 | | 0.055557 | | |
| 17 | 530 | 0.185 | 0.51 | 0.09435 | 0.588843655 | | 0.037766 | | |
| 18 | 540 | 0.125 | 0.49 | 0.06125 | 0.616595002 | | 0.018563 | | |
| 19 | 550 | 0.0625 | 0.46 | 0.02875 | 0.645654229 | | 0.006607 | | |
| 20 | 560 | 0.025 | 0.4 | 0.01 | 0.660693448 | | 0.002407 | | |
| 21 | 570 | 0.01 | 0.34 | 0.0034 | 0.707945784 | | 0.001376 | | |
| 22 | 580 | 0.005 | 0.38 | 0.0019 | 0.72443596 | | 0 | | |
| 23 | 590 | 0 | 0.5 | 0 | 0.741310241 | | 0 | | |
| 24 | 600 | 0 | 0.44 | 0 | 0.758577575 | | 0 | | |
| 25 | | | Sum of SλAλ = | 3.04655 | | Sum of SλAλtλ = | 1.076695 | | |

[symbol]

indicates data missing or illegible when filed

TABLE 2

| Series | R² | Equation | Slope of curve |
|---|---|---|---|
| 1 | 0.992 | Y = −0.0171x + 6.976 | −0.0171 |
| 2 | 0.995 | Y = −0.0151x + 6.297 | −0.0151 |
| 3 | 0.989 | Y = −0.0159x + 6.6282 | −0.0159 |
| 4 | 0.994 | Y = −0.0234x + 9.9407 | −0.0234 |
| 5 | 0.996 | Y = −0.0239x + 10.254 | −0.0239 |
| 6 | 0.990 | Y = −0.02x + 8.4863 | −0.02 |
| 7 | 0.9947 | Y = −0.0194x + 8.0346 | −0.0194 |
| 8 | .9985 | Y = −0.0177x + 6.6418 | −0.0177 |
| 9 | .9976 | Y = −0.01x + 3.560 | −0.01 |

1. A light filter for use at nighttime comprising a light filtering agent and a transparent substrate wherein the light filtering agent has the following characteristics:
a) A high value of MPF—preferably greater than 3
b) An average mesoscopic luminous transmission of the light between 520 nm and 525 nm in a range of 50% to 90%.
c) A minimum fractional increase in errors on the online FM100 color test taken by a person while wearing the light filters over the number of errors taken by the same person while not wearing the light filter to take the test—preferably not more than 20%.
d) An absorption spectrum that wherein the logarithm of the optical absorption are straight lines when plotted against the wavelength over region of visible light.

2. A light filter according to claim 1 wherein the light-filtering agent is melanin

3. A light filter according to claim 1 wherein the light-filtering agent is the polymerization product of 3-hydroxy-kynurinine.

4. A light filter according to claim 1 wherein the light-filtering agent is a derivative of asphalt.
